(19) United States
(12) Patent Application Publication
(10) Pub. No.: US 2008/0257799 A1
(43) Pub. Date: Oct. 23, 2008

(54) Apparatus & method for high speed document collation for insert into newspaper and other printed media

(76) Inventors: Randy R. Seidel, Emmaus, PA (US); Ryan R. Seidel, Emmmaus, PA (US); Richard J. Merwarth, Huron, OH (US)

Correspondence Address: Robert B. Famiglio, Esquire;FAMIGLIO & ASSOCIATES, P.O. Box 1999, Media, PA, 19063, US

(21) Appl. No.: 12/148,604

(22) Filed: Apr. 21, 2008

Related U.S. Application Data
(60) Provisional application No. 60/925,537, filed on Apr. 20, 2007.

(51) Int. Cl. B07C 5/38

(52) U.S. Cl. 209/707

(57) ABSTRACT

An apparatus and method for processing newspaper-type insert media into a newspaper-type jacket using bottom-up collating presenting an inverted shingled stream onto a conveyor means. A feed system picks inserts off of the top of a stack by a series of grippers. Each insert is layered into an inverted shingled stream using bottom-up collation, collecting downstream inserts and placing them below the upstream insert in the proper order. The inverted stream of the system takes advantage of gravity and aerodynamics to reduce flyaway inserts. The system uses a loop of continuous pocket means to receive collected and collated inserts into one side from a stream, while collecting the jacket part for which the insert is intended, processing each individual jacket in a continuous stream to prepare the jacket to be placed properly for acceptance of the collated inserts in a continuous stream.

### CROSS REFERENCES TO RELATED APPLICATIONS

This application claims the benefit of the Applicants' U.S. provisional patent application Ser. No. 60/925,537 filed Apr. 20, 2007 in the United States Patent and Trademark Office.

### BACKGROUND OF THE INVENTION

1. Field of the Invention

The invention relates to an apparatus for and method of processing newspaper-style media to collate individual media into a single final package for delivery to the end user. The invention and method described allows individual stacks of insert material to be collected and processed into a single, unified insert package with each individual group of inserts inserted as a stack at one time within a jacket part such as a newspaper jacket. The inserts are processed into a single stream and automatically inserted in the correct order and group into each individual jacket, and the jacket and the inserted materials thereafter comprise a completed product.

2. Description of the Related Art

The newspaper industry has used inserts collected from various different sources as advertising material and other printed media delivery systems for many years. It is well known to those skilled in the art that collating insertable advertising media from various different sources into a complete package for final insertion into a newspaper jacket can be time consuming, wrought with error and may be problematic when using automation to collect the inserts into a single insertable package, thereafter inserting within the newspaper fold for final delivery as a unitary paper product for a consumer. In the past, the industry has conceived of many different feeding principles such as a paper sheet feed and transport shown in Faltin, U.S. Pat. No. 4,405,122.

Early collection and collating systems have been unsatisfactory because they require human intervention, are prone to flyaway inserts, which require a production line to be stopped, and correction and repair performed manually. Also, prior art systems that attempt automation of the process feed inserts from the bottom of a stack, thereby requiring adjustment for the weight of the insert material at the top of the stack which changes as the stack is used up from the bottom. For years a new system which is less complicated, yet smaller in size, more efficient and error-free has been needed.

To address the failings in the prior art, the present invention and method provides a feeder system which picks inserts off the top of a stack, rather than the bottom of a stack. Using vacuum suckers, each individual insert is taken from the top of a stack of inserts and then moved into the stream using a series of grippers. The disadvantages of the prior art are overcome, because feeding conditions are the same for each insert, allowing the total revolutions per minute of the feeder to remain low while still achieving a high throughput, as in the preferred embodiment which allows 60,000 copies per hour to be processed.

The prior art also suffers from flyaway inserts which causes lost product, because the newsprint media used for inserts is frequently very thin and therefore light. In the environment of a production line and factory, and given the movement of a conveyor belt-like system to move the inserts towards the final product, air can catch the leading end of the insert or get underneath the insert if it is being fed in a normal shingle-stream fashion. A system is needed which takes advantage of an inverted stream environment, thereby using gravity and aerodynamics to eliminate flyaway inserts even at higher conveyor speeds.

The existing art in newspaper insert collating also normally collates inserts to be collected into a package from the top down. This also encourages flyaway inserts and additional lost product. A system is needed in which bottom-up collation takes place by placing the heaviest insert product online first. Downstream inserts that are to be added to the insert package are collated under the current stream, thereby taking advantage of the weight of the inserts that are already online to eliminate flyaway product by stabilizing the downstream inserts being collected below the first insert package.

The present state of the newspaper printing collation art and of newspaper collating for inserts frequently requires that manual labor is used to place bundles of insert into the collating process. Frequently manual labor is used to collect inserts into one package to be either automatically or manually inserted into a newspaper jacket for final delivery to a newspaper reader. There is a need for a modular feeding means to provide for semi-automated insertion of different groups of advertising material or other inserts which can be loaded as one unit in a magazine-type environment.

### SUMMARY OF THE INVENTION

An improved, high speed newspaper insert and collating method and system is disclosed. The invention's improvements includes the feeding of newspaper inserts into a 4″ inverted shingled stream using bottom-up collation. The invention applies the inverted stream to take advantage of gravity and aerodynamics to eliminate flyaway inserts and increase the speed of production. Additional inserts to be collated are placed under the current stream of inserts to take advantage of the weight of the first collected inserts that are already online to stabilize the downstream inserts being fed from the bottom up beneath the existing upstream inserts already laid out in inverted shingle form. The heavier inserts are presented first at a location farthest from the pocket loop collation system, adding additional inserts to the insert conveyor in descending order of weight so that the lightest inserts are placed under the heavier inserts as the pile of inserts in the inverted shingle stream is built up from underneath from each interim conveyor system feeding the insert conveyor from each insert cart beneath the conveyor. As long as heaviest inserts are presented first, other inserts placed underneath the heaviest insert may be of varied weight.

The invention uses track mounted insert stack carts which are loaded in the desired order of presentation in the stream of inserts being processed. The inserts are fed from the top of the stack of inserts using a suction and gripper drum means to feed each set of inserts from the individual carts on the conveyor stream using the said bottom-up collating method. The invention utilizes a pocket loop circular conveyor system which accomplishes the collation of the collected inverted shingle stream inserts and places them neatly, cleanly and at high speeds into the jacket in which the inserts will reside in the final product. The pocket loop uses a series of pocket-like insert document collectors comprised of two plates which meet at a hinge at one end to allow opening and closing the space between them which form a pocket. Each pocket accepts packets being inserted from the closed end or fold into the pocket. The longer side of the jacket is retained in the pocket by two pocket grips. Each jacket, which frequently is a finished newspaper, is aligned along the cut edge by gravity through its motion on the bottom of the pocket loop, thereafter allowing perfect alignment on the upward travel of each individual jacket being prepared to accept the inserts from the insert conveyor. As each pocket in the loop travels upward to accept inserts, the pocket will open which allows the jacket to open under gravity allowing insertion of the insert package. The pocket loop system provides the means to continuously process collected inserts with a jacket using a single system with a minimum of apparatus or process steps.

The invention's feeder takes inserts off the top of a stack of inserts using suckers that insert into a series of grippers. The invention uses this method which is different than the present art which takes inserts to be placed into a newspaper jacket from the bottom of a stack of inserts. By using the disclosed method, the feeding conditions are the same for each insert, as the weight of the stack of inserts does not effect the operation as it would feeding inserts from the bottom of the same stack of inserts. The invention feeds inserts from a feeding cart onto a conveyer system in inverted shingle format to allow cleaner insertion as will be described below.

With the use of bottom-up collation in an inverted stream, the invention takes advantage of gravity and aerodynamics to eliminate flyaway inserts in the stream of inserts being readied for processing and insertion. Bottom-up collation allows the invention to run at very fast speeds without losing products or experiencing flyaway inserts. Since any additional inserts which may be inserted in the existing stream of inserts are collated from the bottom of the already processed inserts, the invention takes advantage of the weight of inserts to hold the additional inserts in place.

The invention takes advantage of track insert loading carts which are track mounted to allow effort-free alignment of each stack of inserts into the production line position. The loading carts also provide the advantage of preloaded inserts in such carts to be delivered by the insert vendor or advertising firm providing the media to be inserted.

The invention uses a pocket loop, being a continuous loop of insert and jacket pockets which is modular and may be placed in the production line at various locations as may be suitable for a particular application. The pocket loop which provides the means to insert the series of inserts that have been collected from the inverted stream on one side of the pocket loop, and the jacket in which the inserts are to be placed are presented on the opposite side of the pocket loop will be described below.

The pocket loop collection means prepares each final product to be removed in a continuous flow to be presented for final shipment without the need for human intervention in processing the inserts with the jackets. The continuous pocket loop utilizes a series of jacket or individual shelf-like, jacket-like pocket devices which include pocket fingers to guide the jacket directly into pocket grippers to hold down and register the overlap on the downward side of the loop system. When the pocket loop system continues in the upward portion of the loop, it uses gravity to hold the paper jacket open in that it is gripped from the top while a collated package is inserted into the main jacket at one time, providing a cleaner package at higher delivery speeds.

A pocket loop system allows the use of variable size inserts such as small cutoffs to full size inserts. Pocket fingers direct a jacket in which the inserts are to be placed into each individual pocket, pocket fingers guide the jacket directly to the pocket grippers in the pocket loop, then hold down and register the overlap on loop down. As the pocket loops up on the reverse side of the pocket loop continuous conveyor, as the pocket loops up on said opposite side, the pocket opens and uses gravity to hold the paper open to accomplish the end result of insertion of the package within the jacket.

It is the object of the invention to provide a means for a feeder system which picks inserts off the top of a stack of inserts using suckers that place each individual insert into a series of grippers rather than use of the traditional method of pulling an insert from the bottom of a stack.

It is also an object of the invention to provide an environment for processing inserts which allow the revolutions per minute of the feeder to remain low while achieving a throughput of 60,000 copies an hour.

It is further an object of the invention to provide a method of stacking and collating inserts in a bottom-up collating environment by using inverted shingled stream collation.

It is yet a further object of the invention to provide a simplified scheme for inserting printed materials into a jacket such as a newspaper in a simplified processing stream which reduces loss, flyaway inserts and remains flexible for easy presentation of insert materials in various sizes and in various order of presentation.

Various other objects of the invention shall become apparent to those knowledgeable about such processes as the details of the invention are explained below. All such uses and objects apparent are considered within the scope of this disclosure as the above objects are representative for illustrative purposes only. The following figures will assist in understanding the operation of the invention and its advantages.

### BRIEF DESCRIPTION OF THE FIGURES

FIG. 1 is a pictorial view of the entire invention, illustrating the apparatus and the production line method in final form.

FIG. 2 is a cutaway view of the invention shown in FIG. 1 more clearly illustrating the relationship of the insert carts, the jacket carts, the production conveyor stream, as well as the pocket loop, in relation to each production stream conveyor.

FIG. 3 is a cutaway pictorial view of the gripper drum mechanism, illustrating the details of the gripping process and the insertion of a stack of inserts into the insert production stream from the bottom up, in accordance with the invention.

FIG. 4 is another view of the process depicted in FIG. 3 from a side perspective, showing the insertion illustrating the selection of the inserts from a cart into the gripper drum system and insertion below the existing upstream insert with insertion of an additional insert to the bottom of the inverted stream being conveyed upstream from the original insert from an earlier insert processed with a similar gripper means.

FIG. 5 is a closeup view of the pocket loop system showing each individual pocket in the loop system and on the downstream side of the jacket conveyor system with an open pocket ready to grip the cut edge of the paper.

FIG. 6 is a similar pictorial view as in FIG. 5 showing the insertion of a newspaper jacket with the fold end in first, with an open pocket ready to grip the cut of the paper.

FIG. 7 is a closeup pictorial view of the pocket loop showing the down-loop side of the apparatus after insertion of each individual jacket part and the closing of the pocket to convey the jacket through the lower end of the loop to be aligned with the jacket edges through the action of gravity.

FIG. 8 is a closeup pictorial view of the upswing side of the pocket loop, where the individual pockets are opened for insertion of each insert as shown.

FIG. 9 is a top-down perspective view of the loop pocket illustrating how the overlapping cut edge of a folded newspaper is held by the pocket finger grippers.

FIG. 10 is a sketch illustrating the difference between a normal shingle stream of the prior art, and the inverted stream used in the present invention with respect to the collection, layering and presentation of the inserts or jackets conveyed to the pocket loop.

FIG. 11 is a top plan view, illustrating ten (10) insert carts and the relationship of the carts in various positions to the conveyor system.

FIG. 12 is a line drawing illustrating configuration of a four-station inserter, showing the end view of each area a cart is placed, with buffer forks and lifter forks shown, and a cutaway view of the sucker/gripper mechanism used to convey each stack of inserts to the conveyor in inverted stream format.

FIG. 13 is a three-part simplified side view of a pocket illustrating a fixed and a movable wall and a flat spring mechanism in various positions.

### DETAILED DESCRIPTION OF THE INVENTION

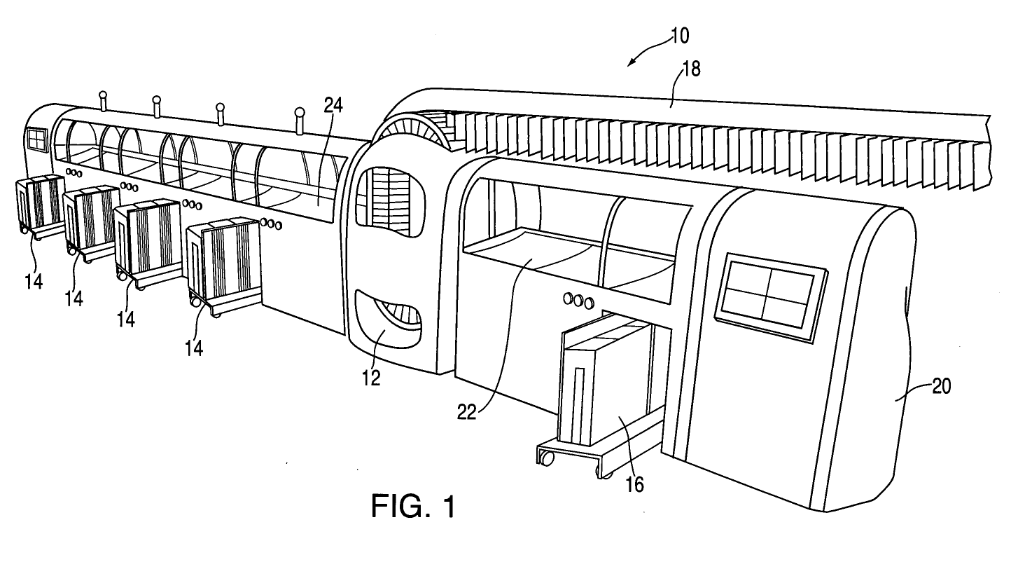

And now the invention will be described with reference to the various figures wherein like numerals refer to like parts. FIG. 1 is a view of the entire system 10 illustrating the major assemblies. FIG. 1 presents the invention in its preferred embodiment in a finished fashion showing the various assemblies comprising the invention covered with typical housings which would be used in a commercial application. Pocket loop system 12, a collection of attached but movable pockets or trays, is placed downstream from jacket stream 22 supplied in a bottom-up collation fashion by insert carts 14. Jackets are most typically newspapers with a folded over presentation with an overlap on one edge, referred to as the cut edge, as is typically found in the newspaper printing industry. Jacket cart 16 is shown on the opposite side of loop 12, feeding a conveyor into loop 12 from the opposite side as the insert stream 24. Control panel 20 contains various controls and instrumentation for the system.

The finished collated product is removed and conveyed away shown in completed product conveyor 18. The product conveyor 18 is a conveyor system which clamps both cut ends of the finished product such as to secure the inserted materials.

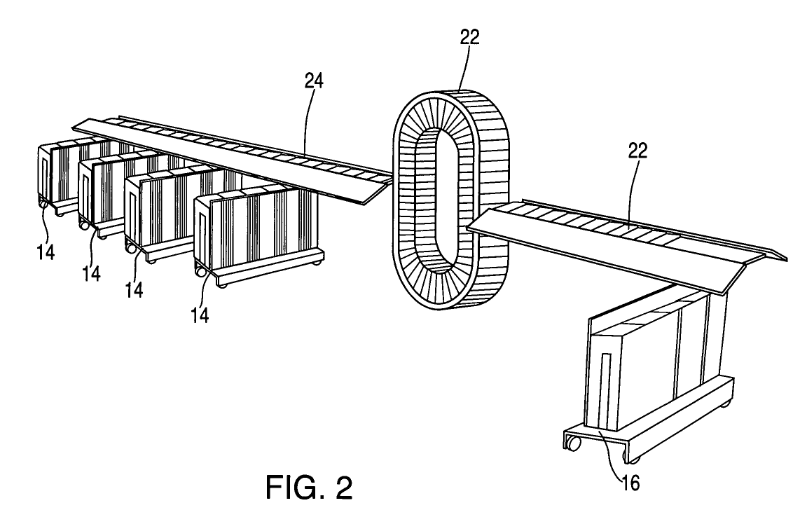

FIG. 2 reveals the simplified interior configuration of system 10 more clearly presenting the arrangement of insert stream 24 and jacket stream 22, both streams presented in an inverted shingle stream to pocket loop 12 for processing.

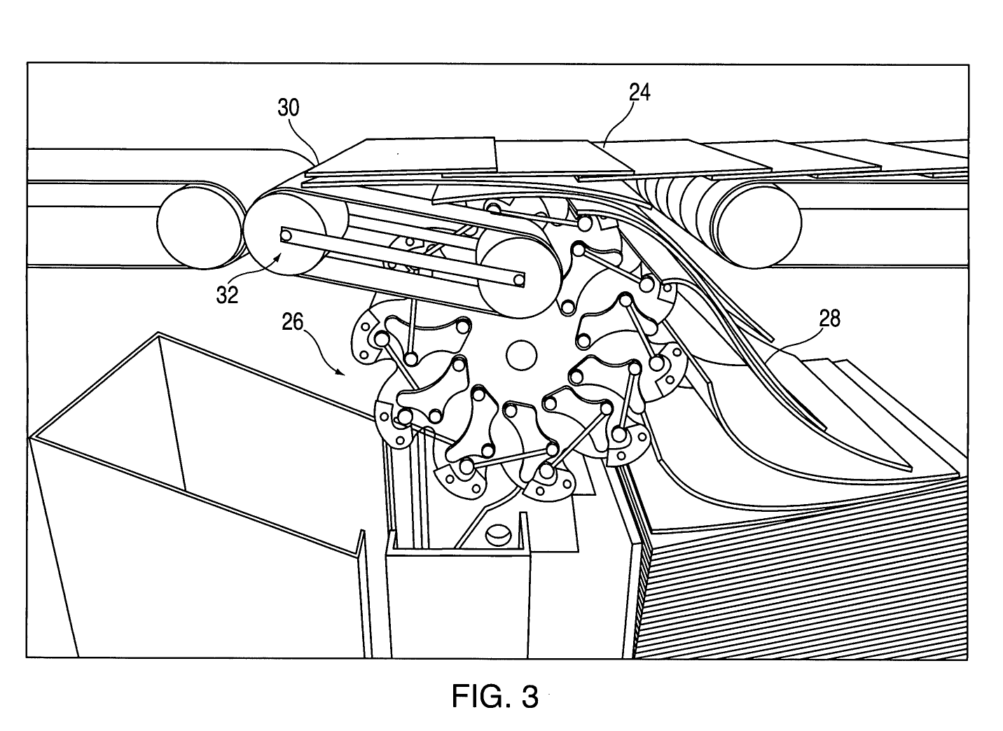

FIG. 3 shows gripper drum 26 which is used to strip away top insert 28 one piece at a time from the top of the insert stack presented by insert cart 14. This method and apparatus is important to the improvement realized in the invention, as the weight of the insert stack becomes unimportant as a factor in the speed or operation of the system. The top insert 28 on a stack presents the same load in each operation unlike processing stacks of inserts fed from the bottom of a stack. The stack in cart 14 is lifted to gripper drum 26 by stepper motors which are controlled as a function of the speed of drum 26. The stepper motors lift the inserts faster as may be needed to keep synchronous with the removal of each insert being introduced into the stream by drum 26.

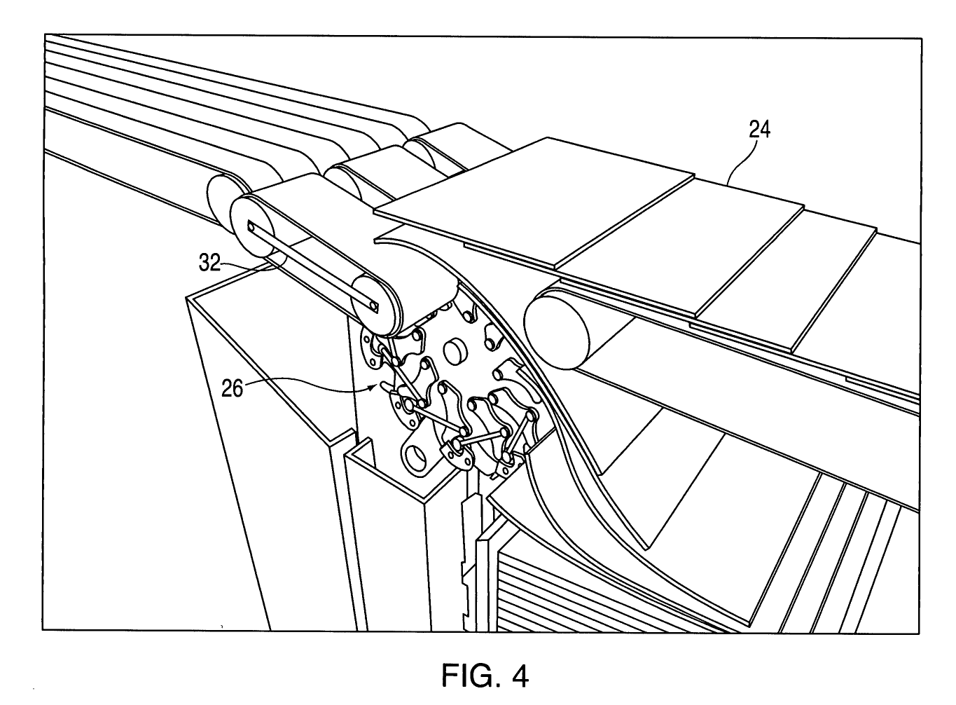

FIG. 4 is another view of drum 26 illustrating the configuration of the drum internally. Those skilled in the art of gripping means for paper sheet handling will appreciate that drum 26 can be configured to remove one insert at a time and feed same from an insert conveyor into the intended stream such as to have a continuous feed of materials to be processed from the stack in the insert cart 14.

Drum 26 incorporates vacuum suction means integrated with a series of grippers to select and feed the sheets of inserts from the pile loaded into each bin. Drum 26 selects and feeds top insert 28 from a cart into insert stream 24 in a bottom-up collation fashion, creating an inverted shingle type insert stream. The inserts processed as shown are inserted into the existing stream at collection point 30.

FIG. 4 illustrates the process in which drum 26 sucks up and then grips each insert and feeds them into the bottom of insert stream 24. Inserts being processed out of the bin by gripper drum 26 are fed to an insert conveyor 32 which is synchronized with the insert stream 24 to place the new insert being placed in the stream to be inserted below upstream inserts introduced into stream 24 by other insert cart sources. It is important in the process to understand that the bottom up feed technique presented allows the heavier weighted inserts to remain on top of each batch of inserts within stream 24. Also, this method allows the presentation of an inverted shingle stream which itself presents flyaway inserts caused by typical air movement and air drafts within a typical production room environment. As stream 24 is conveyed downstream, additional inserts from downstream cart insert positions are feed into the stream from below as shown in the various figures.

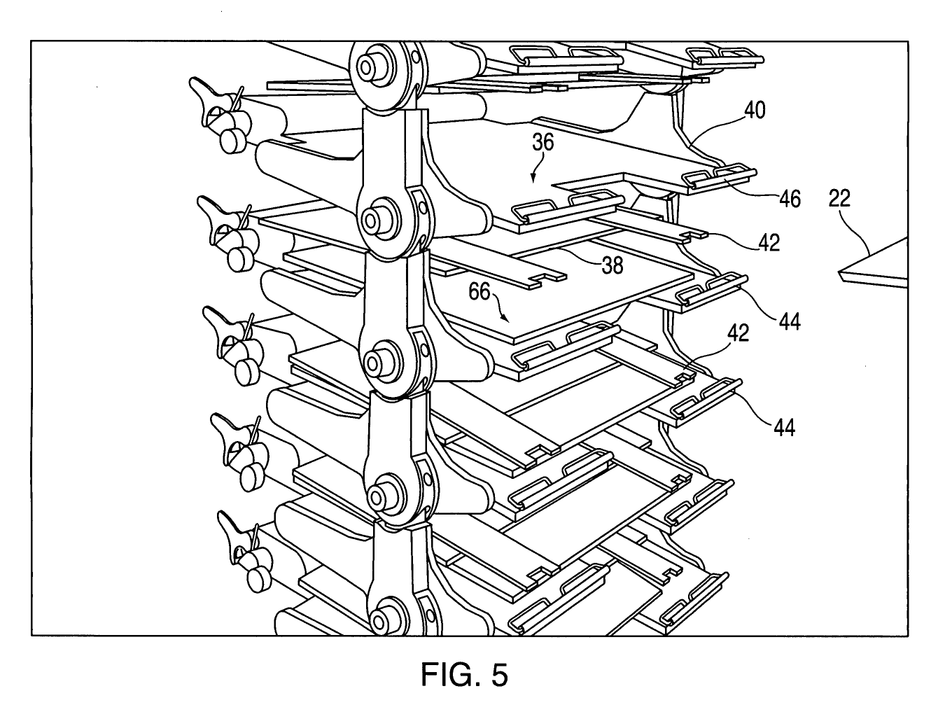

FIG. 5 is a close up view of loop pockets 40 which comprise the system of pocket loop 12, providing detail of how the pocket opens to accept jacket stream 22 as individual jackets are placed into each pocket 40 one jacket at a time as the pocket opens the two plates which comprise the pocket 40. The upper and lower plate of tray 40, referred to herein as pocket 40, are shown in more detail in the figures discussed below. Pocket 40 opens on the downward loop portion of pocket loop 12. An insert from stream 22 is caught in the pocket 40 after being guided by pocket fingers 42.

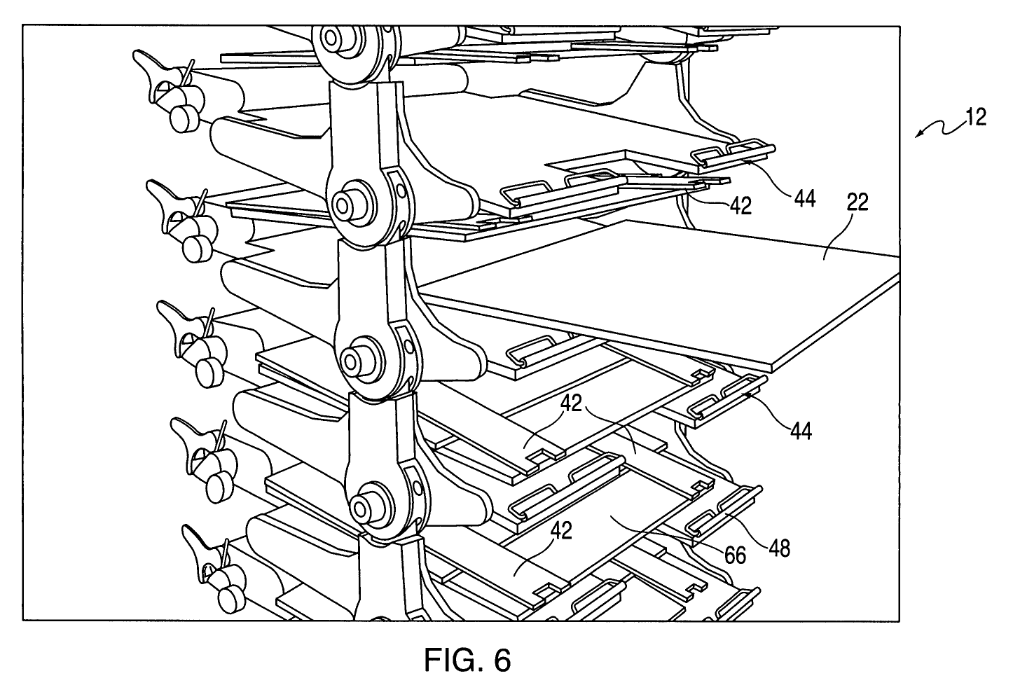

FIG. 6 is a closer view of the loop-down portion of pocket loop 12 illustrating a jacket from jacket stream 22 being shot into pocket 40 as it is opened to accept the next individual jacket as shown.

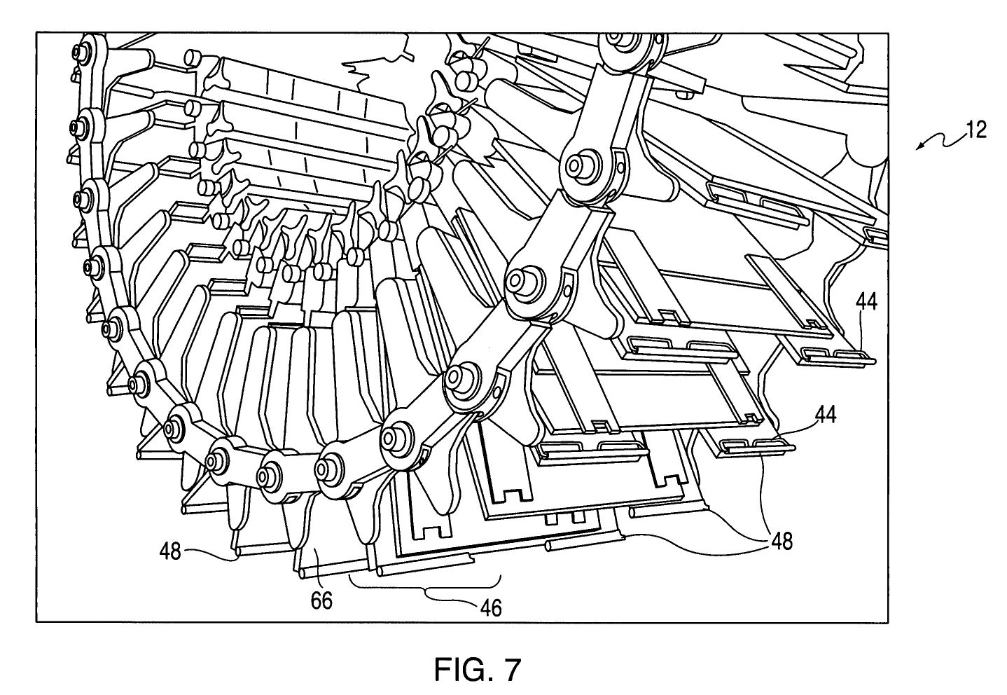

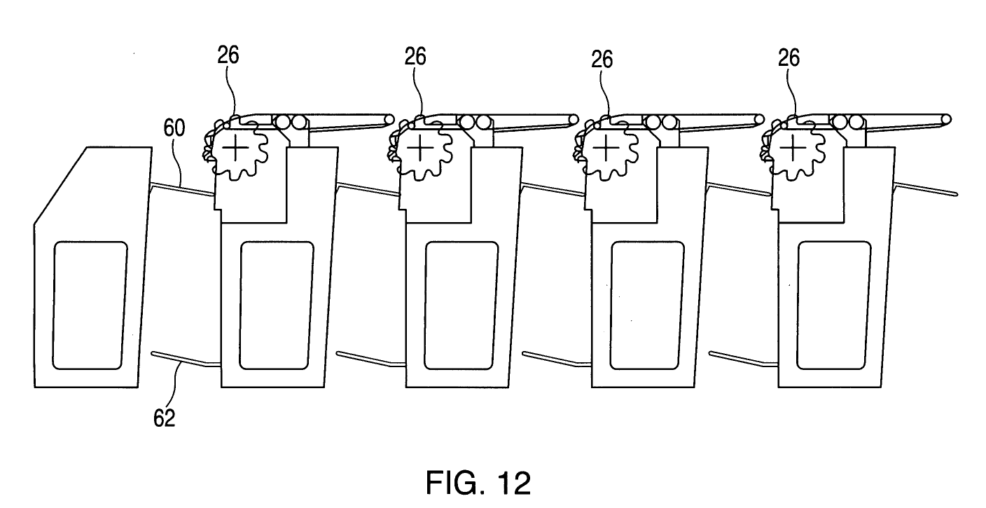

FIG. 7 illustrates an important aspect of the process disclosed. As pocket loop 12 loops down towards pocket loop bottom 46, gravity urges the jacket toward the outer edge pocket ledge 48 to register the overlap edge of the jacket in the correct position, thereby aligning the overlap with grippers 44 which are finger-like grippers fashioned with thin but stiff wire. This method allows variable size jackets to use the same pocket 40 as the edge of the jacket will be aligned with grippers 44 each time due to the action of gravity as the pocket loop 12 loops down as depicted in FIG. 12. By the time a given pocket 40 reaches loop bottom position 46, the pocket grippers 44 have secured the jacket aligned properly with the edge of the pocket and the pocket has closed to hold the jacket securely as depicted in FIG. 7. Pocket grippers 44 will then close on the overlapping cut edge of the jacket to secure it down on the bottom plate of pocket 40. This is an important aspect of the present invention in that the overlapping edge of the jacket within the pocket through the action of grippers 44, will be secured to the plate of the pocket which will become the top plate of pocket 40 as the pocket loops around to the loop-up portion of pocket loop 12. At such time, the jacket will drop open by gravity acting on the shorter cut edge of the jacket while the overlapping edge remains secure to the now top plate being fixed pocket wall 36, the jacket now being held in place by grippers 44.

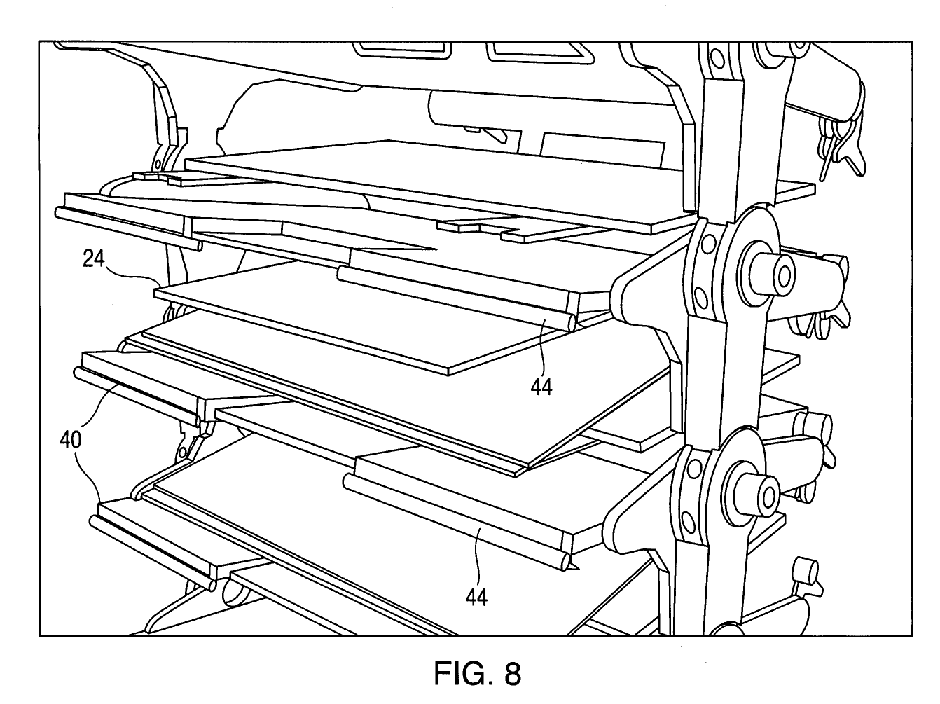

FIG. 8 shows pocket loop 12 with pockets on the loop-up portion of the travel of pocket 40. An individual insert from insert stream 24 is shot into the now open jacket within each individual loop pocket 40 as the pocket opens and the overlapping edge of the jacket remains fixed against the upper plate of the pocket. Gravity causes the jacket to fall open in place as the pocket grippers 44 secure the opposite edge of the cut edge of the jacket. The pocket now contains a fully processed collection of intended inserts and the jacket. The final product as shown continues upward to be collected and removed by the overhead conveyance system gripping and removing each finished product away for bundling shown as conveyor 18 in FIG. 1.

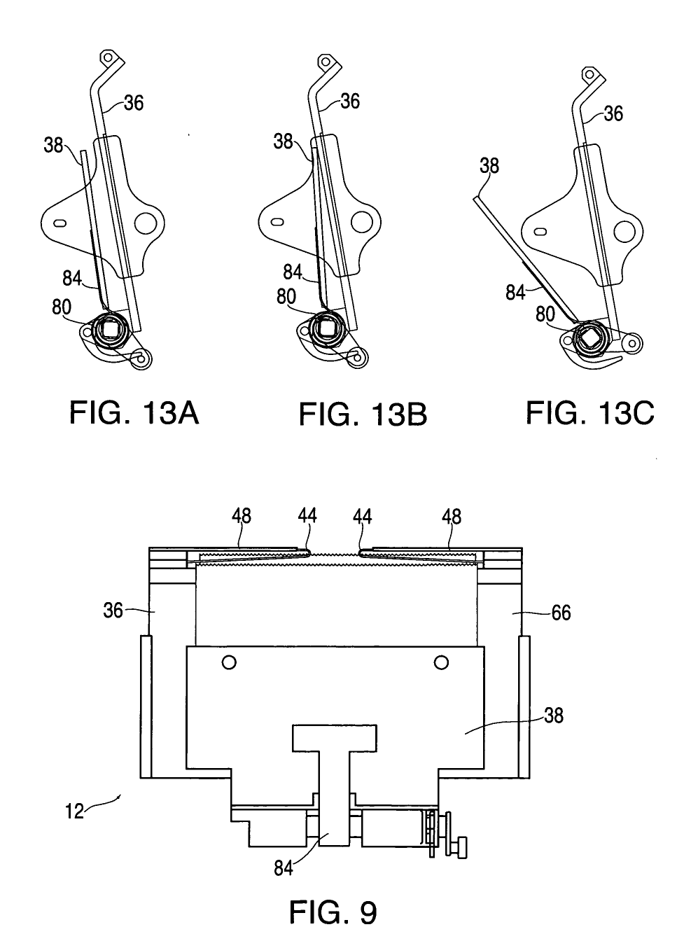

FIG. 9 is a plan view of a top down perspective showing the fixed pocket wall 36 with movable pocket wall 38 covering over jacket 66 and with more detail regarding grippers 44 against the overlapping edge of jacket 66 within the pocket 40. FIG. 9 provides details of the edge of the pockets and the pocket finger grippers 44 in pocket loop 12. Those skilled in the art of conveying systems will appreciate that the mechanical drive for the action of the plates which comprise each pocket can be provided by a series of levers or interactive parts which spacing varies in relationship to the pockets location on the loop. The action of the pocket parts and plates of the pockets are driven by the mechanical motion of the rotation of pocket loop 12 as depicted in the various drawings of the pockets. This mechanism design can vary depending on the need and design criteria.

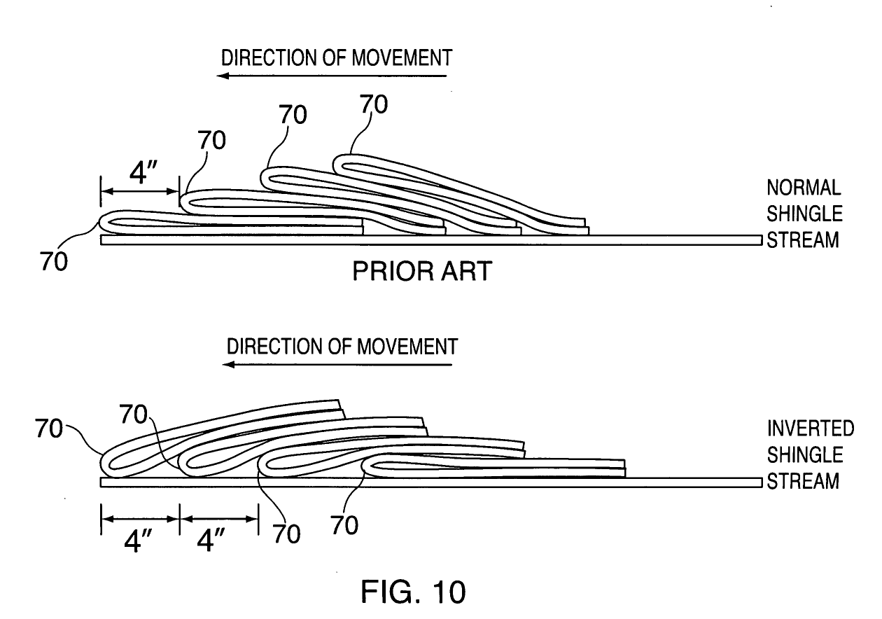

FIG. 10 is an edge view schematic of a normal shingle stream known in the industry and an inverted shingle stream as used in the present invention for comparison. The overlap preferred in the disclosed embodiment is 4 inches. The discovery and use of the inverted shingle stream technique illustrated in FIG. 10 is important in the practice of the present invention. Because of the product flow format demonstrated in the present invention, the inverted shingle stream shown in FIG. 10 prevents leading edge 70 from lifting and being folded back by air flow because of the direction of movement towards the center located pocket loop 12. The prior art shingle layering stream found in existing systems encourages leading edge 70 to lift up and either fly away or shift sufficiently to cause jamming or a need for manual intervention to prevent the paper jackets or inserts from causing system stoppages. Most conventional paper insert jacket processing conveyor systems layer the product on top of each other as they move down the line thereby presenting a normal shingle stream as shown in the prior art designation in FIG. 10.

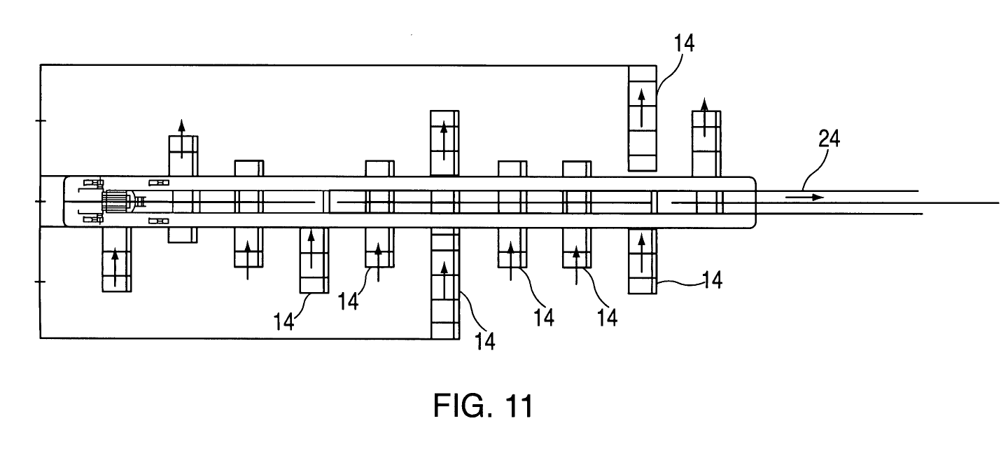

FIG. 11 is a plan view showing a ten insert carts 14 arrangement under insert stream 24. Each cart is in a position to feed the next stack of inserts as each cart 14 holds more than one stack of inserts and feeds each gripper drum at each station.

FIG. 12 reveals typical design dimensions for station inserters in accordance with a four station insert stream. Buffer forks 60 and lifting forks 62 act on the inserts within a cart 14 to raise and position inserts for the drum 26.

As can be seen by FIG. 11 and FIG. 12, the invention can include multiple carts which themselves have multiple stack of inserts allowing the cart to automatically advance by indexing forward, perpendicular to the conveyor streams, to allow additional stacks of inserts or jackets to be lifted onto the conveyor. FIG. 11 shows a variety of different carts 14 at different stages of use as the carts are automatically advanced from one stack to the next as the stacks are consumed. It is particularly useful in that the buffer fork 60 lifter fork 62 as shown, for example in FIG. 12, are lifted out of the way allowing the next stack to be advanced while a particular gripper continues to operate. In such a fashion, it is not necessary to stop the entire system 10 to load new stacks of inserts or jackets as the stream of carts can be made virtually continuous as shown, for example, in FIG. 11.

FIGS. 13A, 13B and 13C are end views of the component parts of a loop pocket 40 which comprises pocket loop 12. Spring mechanism 80 can be seen which are used to provide force necessary to operate pocket grippers 44. Also, flat coil spring leaf 84 on movable pocket wall 38 which comprise pocket 40 is such that force to deflect movable pocket wall 38 increases with the thickness of the jacket and the inserts thereby providing greater holding force for heavier products. Various spring configurations can be used to accomplish the means needed. In the various FIGS. 13A, 13B and 13C it will be appreciated that fixed pocket wall 36 contains a 45 degree bend downward as shown in the various parts of FIG. 13. It should also be noted that for simplicity grippers 44 and loop pocket ledge 48 are not shown for simplicity. The 45 degree downward tilt of wall 36 can be used in an improvement of the operation of pocket loop 12 particularly with an alternative embodiment which incorporates a knuckle or rotation ability at the 45 degree bend of wall 36 as displayed in the various FIG. 13. Nevertheless, the preferred embodiment disclosed with a straight, non-curved wall 36 works well as presented.

Although the invention has been described in accordance with a preferred embodiment and an alternative embodiment, it will be appreciated by those skilled in the art that the application of the present invention is useful in a variety of configurations and designs not specifically described above. All such designs and applications are considered to be within the scope of the present disclosure, and the invention is applicable across a wide variety of applications. Such applications are considered within the scope and spirit of the present invention.

What is claimed is:

1. A method for inserting and collating paper inserts into a stream of jackets comprised of the steps of:
placing the papers to be inserted into the jackets into a stack to be fed off the top of said stack by bottom up movement of the stack;
feeding the said paper inserts from the top of the said stack onto a conveyor system in inverted shingled streams upon said conveyor system;
folding the jackets receiving said inserts in half with a cut edge extending past the opposite edge when folded;
presenting said folded jackets in an inverted shingled stream to receive said inserts sequentially;
placing each jacket to receive the said inserts into a tray, each tray being part of a multiple tray, vertically traveling, rotating loop conveyor where each tray receives one jacket on the vertically descending side of the rotating loop conveyor;
rotating the said loop conveyor to present the tray holding the jacket on the opposite, upward travel side of the said loop conveyor allowing the cut edge of the jacket within the tray to align with the lower edge of the tray through the action of gravity;
gripping the cut edge of each individual jacket to secure the cut edge to each individual tray after each jacket is placed into each tray;
opening the closed tray on the upward travel side of said loop conveyor while gripping the cut edge of the jacket to allow the fold to open by operation of gravity;
feeding the insert to be added to the inside of the folded jacket;
closing the tray after said insert is fed into the jacket; and
removing the jacket with said insert in place from the loop conveyor.

2. The method of claim 1 wherein further the placing of the papers to be inserted are stacked in and fed from a movable cart.

3. The method of claim 1 wherein further more than one stack of papers to be inserted are fed onto said conveyor system simultaneously from different points along the said conveyor system.

4. The method of claim 3 wherein further the said more than one stack of papers fed onto said conveyor system from different points are arranged along the said conveyor in order of heaviest inserts being fed farthest from said pocket loop to the lightest inserts to be fed closest to said pocket loop.

5. The method of claim 2 wherein further more than one stack of papers to be inserted are fed onto said conveyor system simultaneously from more than one said movable carts.

6. The method of claim 5 wherein further the said more than one stack of papers fed onto said conveyor system from different points are arranged along the said conveyor in order of heaviest inserts being fed farthest from said pocket loop to the lightest inserts to be fed closest to said pocket loop.

7. Apparatus for placing paper inserts into the inside of a folded jacket comprising:
a bin for stacking inserts to be fed into the apparatus, said bin lifting the stack of inserts from the bottom up to present the top insert from the stack upward to a first conveyor system to create a stream of inserts;
a gripping device to grip each insert from the top of said bin and present each insert to an insert conveyor to present said insert to a first conveyor system by placing each said insert under any previous insert present on said first conveyor system;
a first conveyor system to accept a stream of at least one set of inserts being presented in an inverted shingle stream and then transport said at least one set of inserts in said inverted shingle stream from the point of each said stream creation to a point downstream to intersect with and place each individual insert sequentially into a folded jacket in an individual pocket, said individual pocket being connected to a pocket loop, while said pocket is being conveyed in a substantially vertical direction by said pocket loop;
a bin for stacking folded jackets to feed into the apparatus which lifts the stack of jackets from the bottom up to present the top jacket upward from the stack to a second conveyor system;
wherein said stacked jackets are presented with the overlapping edge of the cut facing upward in the stream;
a second conveyor system to accept the stream of folded jackets fed from said bin into which said paper inserts are to be placed from the point of each said stream creation to a point downstream to intersect with and place each individual folded jacket sequentially into an individual pocket;
a pocket loop system comprised of a series of individual pockets, said pockets including a first plate and a second plate which are configured to open and close by creating a slot between them for accepting, in coordinated sequence, the said stream of inserts and the said stream of jackets;
each said pocket in said pocket loop being comprised of a set of grippers to secure the cut edge of the jacket against the pocket after said jackets are introduced into the pocket from the jacket stream;
wherein after each jacket is secured into a pocket, the pocket closes as it continues traveling on the downward side around the said loop to present the pocket on the upward side to reopen the pocket but maintain the said gripper against the overlapping cut edge of the jacket to cause the jacket to fall open at the fold presenting the open fold to accept an individual insert from said first conveyor system;
wherein further the jacket with the insert is then conveyed upward in the said pocket loop to present the jacket with the insert to a gripper to remove the jacket with the insert to a finished product stream away from the pocket before said pocket returns to the downward side of said pocket loop.

8. The apparatus of claim 7 wherein further said jacket is a folded newspaper with an overlap of its edges when folded over such that the cut ends of said folded newspaper are adjacent to each other.

9. Apparatus for placing paper inserts into the inside of a jacket comprising:
a bin for stacking inserts to be fed into the apparatus, said bin lifting the stack of inserts from the bottom up to present the top insert from the stack upward to a first conveyor system to create a stream of inserts;
a gripping device to grip each insert from the top of said bin and present each insert to an insert conveyor to present said insert to a first conveyor system by placing each said insert under any previous insert present on said first conveyor system;
a first conveyor system to accept a stream of at least one set of inserts being presented in an inverted shingle stream and then transport said at least one set of inserts in said inverted shingle stream from the point of each said stream creation to a point downstream to intersect with and place each individual insert sequentially into a folded jacket in an individual pocket, said individual pocket being connected to a pocket loop, while said pocket is being conveyed in a substantially vertical direction by said pocket loop;
a bin for stacking folded jackets to feed into the apparatus which lifts the stack of jackets from the bottom up to present the top jacket upward from the stack to a second conveyor system;
wherein said stacked jackets are presented with the overlapping edge of the cut facing upward in the stream and the folded edge becoming the leading edge in the said stream;
a second conveyor system to accept the stream of folded jackets fed from said bin into which said paper inserts are to be placed from the point of each said stream creation to a point downstream to intersect with and place each individual folded jacket within said jacket stream sequentially into an individual pocket;
a pocket loop system comprised of a series of individual pockets in a vertically rotating loop, said pockets including a first plate and a second plate which are configured to open and close by creating a slot between them for accepting, in coordinated sequence, the said stream of inserts and the said stream of jackets and create a ledge to align the cut edge of the jacket through the action of gravity on the jacket when the pocket travels downward and around the bottom of said pocket loop;
wherein after each jacket is secured into a pocket, the pocket is configured to close to maintain the jacket within the pocket as it continues traveling on the downward side around the said loop to present the pocket on the upward side to reopen the pocket;
each said pocket in said pocket loop being comprised of a set of finger grippers to secure the cut edge of the jacket against the pocket after said pocket containing a jacket is presented in the upward pocket travel side of said pocket loop system allowing gravity to open the jacket to accept an insert from said stream of inserts;
wherein further after an individual closing of the said finger gripper against the overlapping cut edge of the jacket to cause the jacket to fall open at the fold presenting the open fold to accept an individual insert from said first conveyor system;
wherein further the jacket with the insert is then conveyed upward in the said pocket loop to present the jacket with the insert to a gripper to remove the jacket with the insert to a finished product stream away from the pocket before said pocket returns to the downward side of said pocket loop.

10. The apparatus of claim 9 wherein said jacket is a newspaper.
